(19) United States
(12) Patent Application Publication
(10) Pub. No.: US 2020/0278754 A1
(43) Pub. Date: Sep. 3, 2020

(54) DISPLAY PROCESSING APPARATUS, DISPLAY PROCESSING METHOD, AND PROGRAM

(71) Applicant: SONY CORPORATION, TOKYO (JP)

(72) Inventors: MASAKI HANDA, KANAGAWA (JP); TAKESHI OHASHI, KANAGAWA (JP); TETSUO IKEDA, TOKYO (JP)

(21) Appl. No.: 16/647,557

(22) PCT Filed: Jul. 13, 2018
(86) PCT No.: PCT/JP2018/026600

§ 371 Date: Mar. 16, 2020

(30) Foreign Application Priority Data
Sep. 25, 2017 (JP) 2017-183785

(51) Int. Cl. G06F 3/01; G09G 5/36; G06K 9/00

(52) U.S. Cl. CPC G06F 3/017; G06K 9/00355; G09G 5/36

(57) ABSTRACT

[Problem] In a case where information is projected and displayed, confidentiality is ensured by controlling display according to a state of an object. [Solution] A display processing apparatus according to the present disclosure includes: a state acquisition unit configured to acquire a spatial state of an object; and a display control unit configured to control display of projected information according to the state of the object including a posture of the object. With this configuration, in a case where information is projected and displayed, it is possible to ensure confidentiality by controlling display according to the state of the object.

### FIELD

The present disclosure relates to a display processing apparatus, a display processing method, and a program.

### BACKGROUND

Conventionally, Patent Literature 1 cited below discloses a technique for, at the time of projecting an image, obtaining satisfactory visibility even when an object exists between a projection unit and a target to be projected.

### CITATION LIST

### Patent Literature

Patent Literature 1: JP 2012-208439 A

### SUMMARY

### Technical Problem

In the technique disclosed in the above patent literature, an object existing between the projection unit and the target to be projected is detected, and processing is performed so that a main image is not projected as it is onto the detected object. However, in the technique disclosed in the above patent literature, a position of the detected object is determined on the basis of two-dimensional information. Thus, it is difficult to perform optimal display according to a spatial state of the object. Further, in the technique disclosed in the above patent literature, the following problem arises: projected information can be visually recognized by a plurality of people.

Meanwhile, for example, it is preferable that confidential information or the like can be seen only by a specific person and cannot be seen by other people.

In view of this, it has been required to ensure confidentiality by, in a case where information is projected and displayed, controlling the display according to a state of the object.

### Solution to Problems

According to the present disclosure, a display processing apparatus is provided that includes: a state acquisition unit configured to acquire a spatial state of an object; and a display control unit configured to control display of projected information according to the state of the object including a posture of the object.

Moreover, according to the present disclosure, a display processing method is provided that includes: acquiring a spatial state of an object; and controlling display of projected information according to the state of the object including a posture of the object.

Moreover, according to the present disclosure, a program is provided that causes a computer to function as: means for acquiring a spatial state of an object; and means for controlling display of projected information according to the state of the object including a posture of the object.

### Advantageous Effects of Invention

As described above, according to the present disclosure, it is possible to ensure confidentiality by, in a case where information is projected and displayed, controlling the display according to a state of an object.

Note that the above effects are not necessarily limited, and any of effects described in the present specification or other effects that can be grasped from the present specification may be obtained together with or instead of the above effects.

### BRIEF DESCRIPTION OF DRAWINGS

FIG. 1 is a schematic diagram illustrating a schematic configuration of an image projection system according to an embodiment of the present disclosure.

FIG. 2 is a block diagram illustrating a configuration of a projector apparatus.

FIG. 3 is a flowchart of processing performed in an image projection system.

FIG. 4 is a schematic diagram illustrating an example of display on a table.

FIG. 5 is a schematic diagram illustrating a state in which, in a case where a user stretches out his/her hand on a table, a posture of the hand is estimated.

FIG. 6 is a schematic diagram illustrating a flow of processing of estimating a posture of a hand.

FIG. 7 is a schematic diagram illustrating a state in which a posture of a hand is estimated by the processing of FIG. 6.

FIG. 8 is a flowchart of a flow of display control processing according to a posture of a hand.

FIG. 9 is a schematic diagram illustrating an example where content is moved to a palm with a specific gesture and is operated.

FIG. 10 is a schematic diagram illustrating an example where content on a palm is moved to an arm.

FIG. 11 is a schematic diagram illustrating operation of displaying the back side of a playing card whose front side is displayed.

FIG. 12 is a schematic diagram illustrating operation of returning a playing card onto a table.

FIG. 13 is a schematic diagram illustrating another operation of returning playing cards onto a table.

FIG. 14 is a schematic diagram illustrating a method of returning playing cards onto a hand.

FIG. 15 is a schematic diagram illustrating operation of passing a playing card to another person.

FIG. 16 is a schematic diagram illustrating an example where a change in an angle of a hand is prompted by display on a table.

FIG. 17 is a schematic diagram illustrating an example of display on a table, which is a schematic diagram illustrating a state in which a user holds a card with his/her hand.

FIG. 18 is a schematic diagram illustrating a configuration example where a plurality of projector apparatuses each including an input unit and an output unit is provided, and each of the plurality of projector apparatuses is controlled by a server.

FIG. 19 illustrates an example where display is performed in a projection area of a table with the configuration illustrated in FIG. 18.

FIG. 20 is a schematic diagram illustrating processing of detecting a region of a hand by using a hand detection unit.

FIG. 21A is a schematic diagram illustrating a skeleton model of a hand.

FIG. 21B is a schematic diagram illustrating an example where a gesture of turning over a hand is recognized by detecting transition of a skeleton model from the back side to the front side on the basis of a skeleton model of a hand.

FIG. 21C is a schematic diagram illustrating an example where a gesture of clenching a hand is recognized by detecting transition of a skeleton model from an open state to a closed state.

FIG. 22A is a schematic diagram illustrating an example where display information for reversing a displayed playing card is generated in a case where a gesture of turning over a hand is recognized.

FIG. 22B is a schematic diagram illustrating an example where display information for deleting a displayed playing card is generated in a case where a gesture of clenching a hand is recognized.

### DESCRIPTION OF EMBODIMENTS

Hereinafter, preferred embodiments of the present disclosure will be described in detail with reference to the accompanying drawings. In this specification and the drawings, components having substantially the same functional configuration will be denoted by the same reference sign, and description thereof will not be repeated.

Description will be made in the following order.

1. Configuration example of system

2. Processing performed in image projection system

3. Examples of display on screen

4. Estimation of posture of hand by hand posture estimation unit

5. Display control according to posture of hand

6. Examples of specific operation

7. Examples of operation using object other than hand

8. Examples of control by server

1. Configuration Example of System

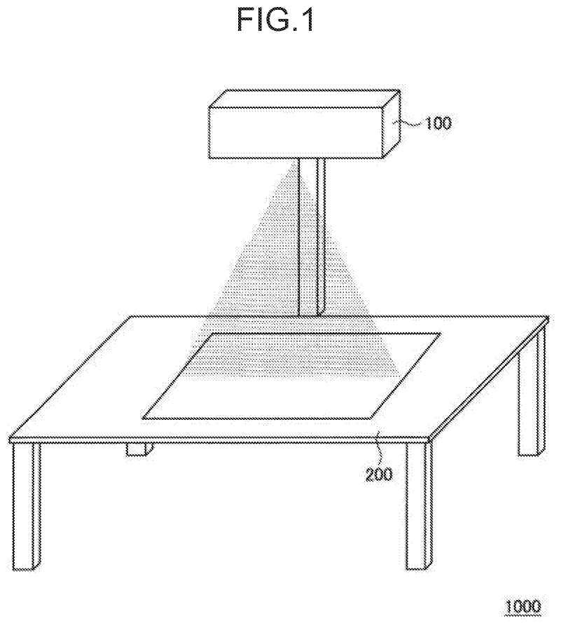

First, a schematic configuration of a projection system 1000 according to an embodiment of the present disclosure will be described with reference to FIG. 1. The projection system 1000 includes a projector apparatus 100 and a table 200 serving as a target to be projected.

In the projection system 1000, for example, the table 200 having a flat projection plane is placed on the floor, and an output unit 116 of the projector apparatus 100 is provided above the table 200 so as to face downward.

In the image projection system 100, an image is projected from the output unit 116 of the projector apparatus 100 provided above the table 200 onto the projection plane of the table 200 provided below the projector apparatus, thereby displaying the image on the table 200.

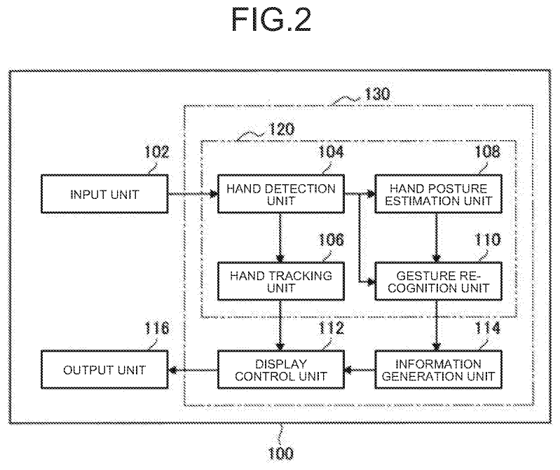

FIG. 2 is a block diagram illustrating a configuration of the projector apparatus 100. The projector apparatus 100 includes an input unit 102, a hand detection unit 104, a hand tracking unit 106, a hand posture estimation unit 108, a gesture recognition unit 110, a display control unit 112, an information generation unit 114, and the output unit 116.

The input unit 102 is a device for, by using a hand of a user on a screen 102 as an object to be detected, acquiring user operation on the basis of a state (position, posture, movement, or the like) of the object. For example, the input unit 102 includes an RGB camera serving as an image sensor, a stereo camera or a time-of-flight (TOF) camera serving as a distance measurement sensor, a structured light camera, and the like. Therefore, it is possible to acquire a distance image (depth map) regarding the object on the basis of information detected by the input unit 102.

The hand detection unit 104 detects a region of the hand from the image on the basis of the information acquired from the input unit 102. There are a method of using an image of the RGB camera and a method of using an image of the distance measurement sensor, and the methods are not particularly limited.

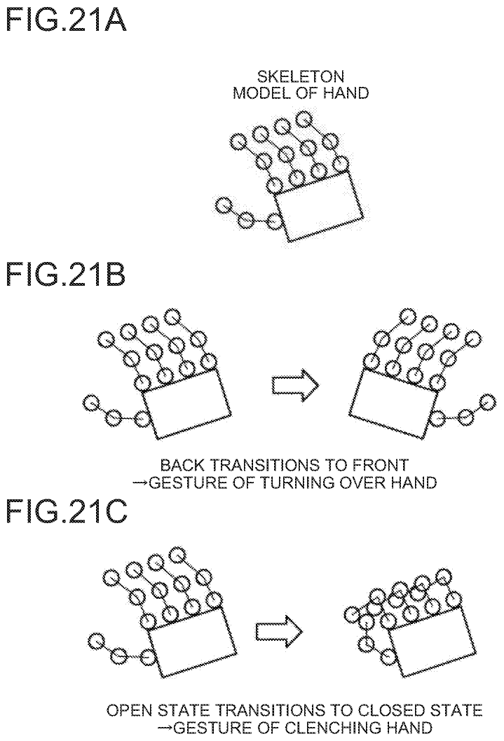

For example, the region of the hand can be detected by performing block matching between a hand template image previously held in a memory or the like and the image acquired by the input unit 102. By using the distance image (depth map), the hand detection unit 104 can detect a position of the hand in a depth direction with respect to the projection plane of the table 200 and a position of the hand in a direction along the projection plane. Specifically, FIG. 20 is a schematic diagram illustrating processing of detecting the region of the hand by using the hand detection unit 104. As illustrated in FIG. 20, a region that is closer to the camera than the plane of the table is detected from a camera image, and a part of the detected region that is in contact with an edge of the image is extracted. Then, a tip end opposite the edge of the image is set as a position of a hand candidate. Thereafter, skin color detection is performed on the hand candidate. Thus, a hand can be detected.

Upon receipt of the detection result from the hand detection unit 104, the hand tracking unit 106 takes correspondence between the hand detected in a previous frame and the hand detected in a current frame, thereby tracking the position of the hand. As a tracking method, there are known a method of associating objects in close positions and other tracking techniques. However, the methods are not particularly limited.

Upon receipt of the detection result from the hand detection unit 104, the hand posture estimation unit 108 estimates a posture of the hand by using the image of the distance measurement sensor. At this time, by regarding a palm or back of the hand as a plane, an angle of the plane is estimated. An estimation method will be described later.

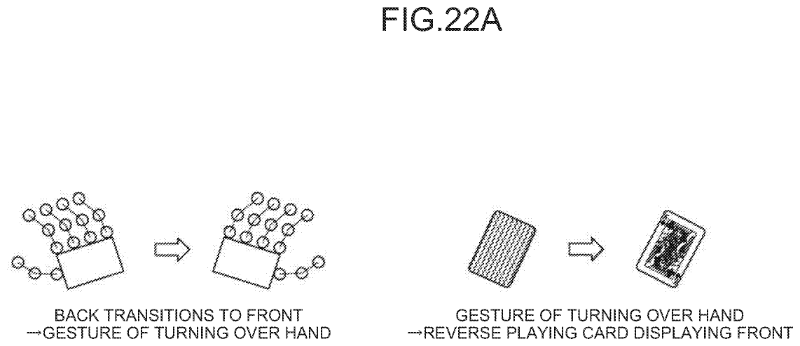

Upon receipt of the detection results of the hand detection unit 104 and the hand posture estimation unit 108, the gesture recognition unit 110 recognizes a gesture of user operation. A method of recognizing a gesture by estimating a skeleton model of a hand is common, and the gesture recognition unit 110 can recognize a gesture by using such a method. For example, the gesture recognition unit 110 performs matching among a gesture previously held in the memory or the like, the position of the hand detected by the hand detection unit 104, and the posture of the hand estimated by the hand posture estimation unit 108, thereby recognizing the gesture. Specifically, FIGS. 21A to 21C are schematic diagrams illustrating examples of recognition of a gesture. FIG. 21A is a schematic diagram illustrating a skeleton model of a hand. FIG. 21B is a schematic diagram illustrating an example where a gesture of turning over a hand is recognized by detecting transition of the skeleton model from the back side to the front side on the basis of the skeleton model of the hand. FIG. 21C is a schematic diagram illustrating an example where a gesture of clenching a hand is recognized by detecting transition of the skeleton model from an open state to a closed state. By using the skeleton model illustrated in FIG. 21A, it is possible to recognize the gestures illustrated in FIGS. 21B and 21C on the basis of positions of feature points indicated by marks “o”.

The hand detection unit 104, the hand tracking unit 106, the hand posture estimation unit 108, and the gesture recognition unit 110 described above function as a state acquisition unit 120 that acquires a spatial state of the hand including the posture of the hand (object). The state acquisition unit 120 can acquire the state of the hand within a projection area 202 or out of the projection area 202.

Upon receipt of the gesture recognition result by the gesture recognition unit 110, the information generation unit 114 generates information corresponding to the user operation.

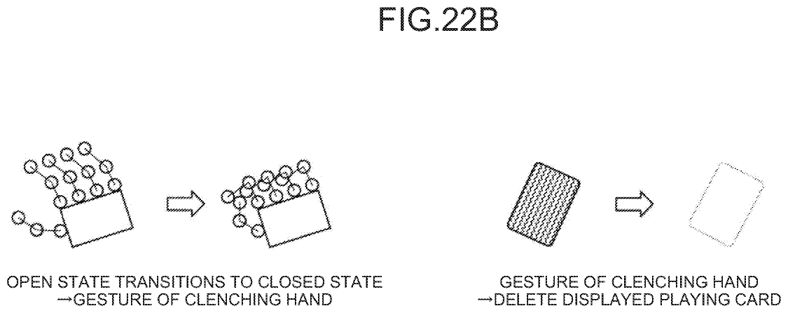

For example, the information generation unit 114 compares display information corresponding to a gesture held in advance with the gesture recognition result, and generates display information corresponding to the gesture recognition result. The information generation unit 114 stores context of the generated information in the memory or the like. Specifically, FIGS. 22A and 22B are schematic diagrams illustrating examples of generating display information. FIG. 22A is a schematic diagram illustrating an example where display information for reversing a displayed playing card is generated in a case where a gesture of turning over the hand illustrated in FIG. 21B is recognized. FIG. 22B is a schematic diagram illustrating an example where display information for deleting a displayed playing card is generated in a case where a gesture of clenching the hand illustrated in FIG. 21C is recognized.

Upon receipt of the information from the hand tracking unit 106 and the information generation unit 114, the display control unit 112 performs control so that the display information generated by the information generation unit 114 is displayed at a predetermined position on the table 200. Specifically, the display control unit 112 can perform control so that the display information generated by the information generation unit 114 is displayed at the position of the hand of the user tracked by the hand tracking unit 106. The output unit 116 includes, for example, a projection lens, a liquid crystal panel, a lamp, and the like, and outputs light under the control of the display control unit 112, thereby outputting an image to the table 200. As a result, content is displayed on the table 200.

In the configuration in FIG. 2, a display processing apparatus 130 according to this embodiment includes the hand detection unit 104, the hand tracking unit 106, the hand posture estimation unit 108, the gesture recognition unit 110, the display control unit 112, and the information generation unit 114. Each component in FIG. 2 can be configured by hardware or a central processing unit such as a CPU and a program for causing the central processing unit to function. Further, the program can be stored in a recording medium such as a memory provided in the projector apparatus 100 or a memory connected to the projector apparatus 100 from the outside.

2. Processing Performed in Image Projection System

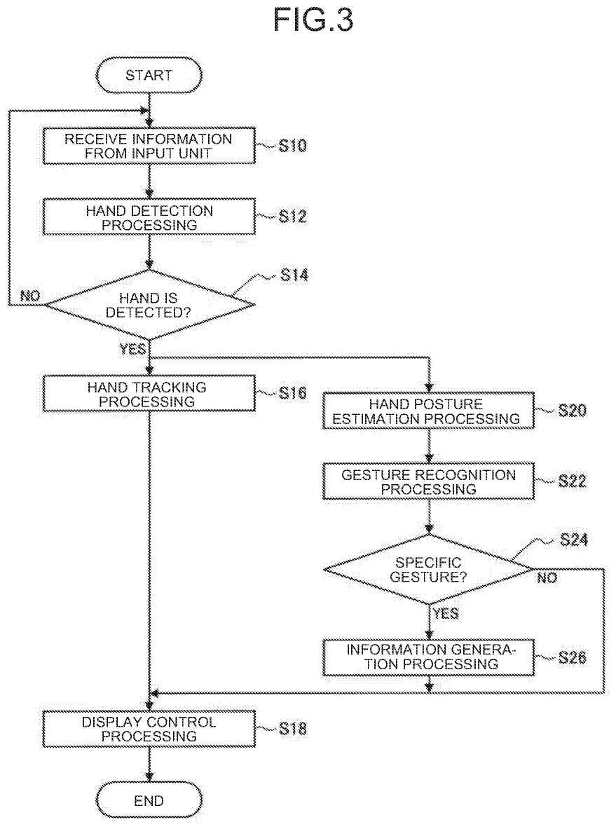

FIG. 3 is a flowchart of processing performed in the projection system 1000 according to this embodiment. First, in Step S10, processing of receiving information from the input unit 102 is performed. In the next Step S12, the hand detection unit 104 performs processing of detecting the hand of the user on the table 200.

In the next Step S14, the hand detection unit 104 determines whether or not the hand has been detected. When the hand is detected, the processing proceeds to Step S16. In Step S16, the hand tracking unit 106 performs processing of tracking the hand of the user.

The processing in Steps S20 to S26 is performed in parallel with the processing in Step S16. In Step S20, the hand posture estimation unit 108 performs processing of estimating the posture of the hand. After Step S20, the processing proceeds to Step S22, and the gesture recognition unit 110 performs processing of recognizing a gesture.

In the next Step S24, it is determined whether or not the gesture recognized by the gesture recognition unit 110 is a specific gesture. When the gesture is a specific gesture, the processing proceeds to Step S26. In Step S26, the information generation unit 114 performs processing of generating display information corresponding to the specific gesture.

After Steps S16 and S26, the processing proceeds to Step S28. In Step S28, based on the result of the hand tracking processing in Step S16 and the information generation processing in Step S26, the display control unit 112 performs processing for display control. In this way, display is performed on the table 200 on the basis of the result of the hand tracking processing and the result of the information generation processing.

3. Examples of Display on Table

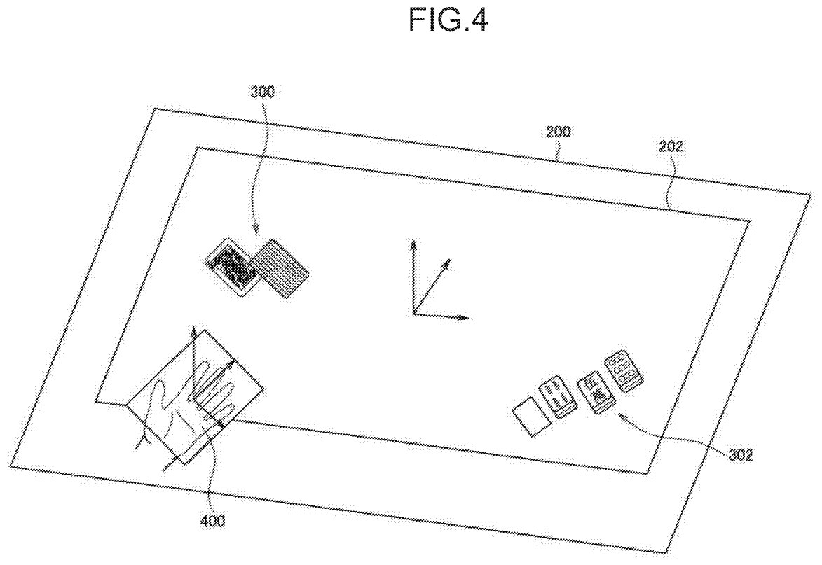

FIG. 4 is a schematic diagram illustrating an example of display on the table 200. In FIG. 4, the projection area 202 indicates a projection area on the table 200 by the projector apparatus 100. Content (A) 300 and content (B) 302 are projected and displayed in the projection area 202. Herein, FIG. 4 illustrates an example where playing cards are displayed as the content (A) 300 and an example where mahjong tiles are displayed as the content (B) 302. However, the displayed content is not particularly limited.

4. Estimation of Posture of Hand by Hand Posture Estimation Unit

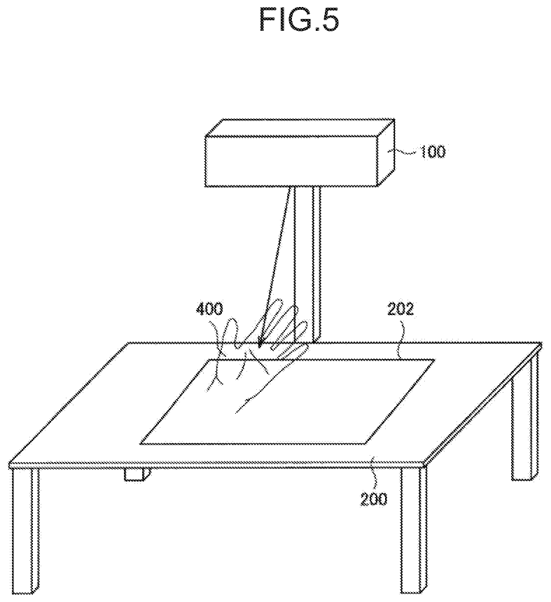

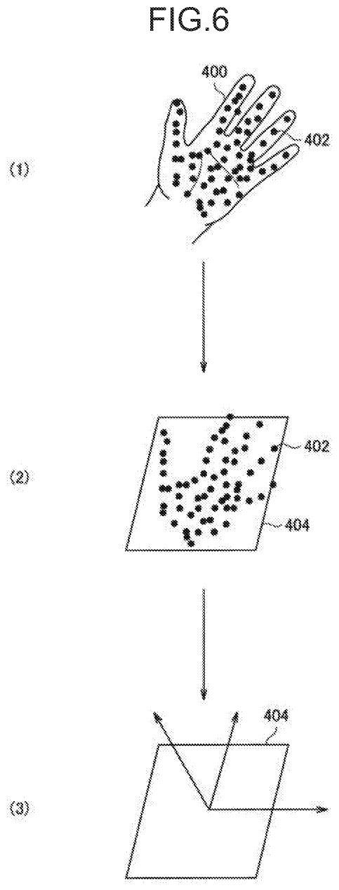

FIGS. 5 and 6 are schematic diagrams illustrating estimation of the posture of the hand by the hand posture estimation unit 108. FIG. 5 is a schematic diagram illustrating a state in which, in a case where the user stretches out the hand 400 on the table 200, the posture of the hand 400 is estimated. FIG. 6 is a schematic diagram illustrating a flow of processing of estimating the posture of the hand 400.

Estimation of the posture of the hand is sequentially performed according to Steps (1) to (3) of FIG. 6. As illustrated in FIG. 6, first, in Step (1), a three-dimensional position of each point 402 on the palm is obtained on the basis of the distance image (depth map) obtained from the input unit 102. In the next Step (2), plane fitting is performed on the obtained point group by using a method such as a least squares method or a RANSAC method. As a result, a plane 404 including the point group is obtained. In the next Step (3), the center of gravity of the point group is set as a position of the palm, and a tilt (pitch, yaw, roll) of the plane 404 is set as the posture of the hand. Thus, the estimation of the posture of the hand is terminated.

5. Display Control According to Posture of Hand

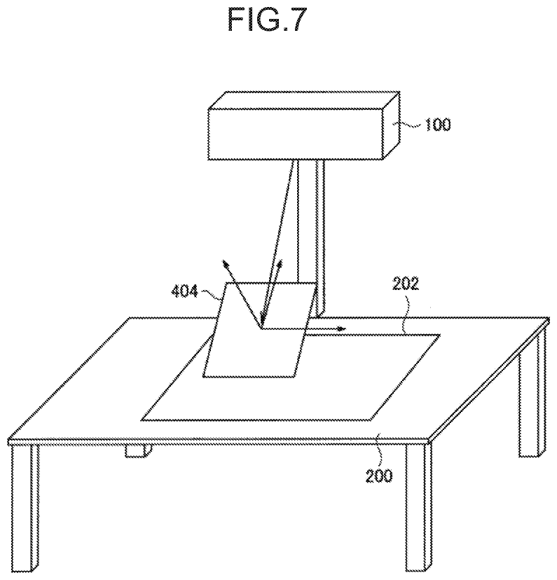

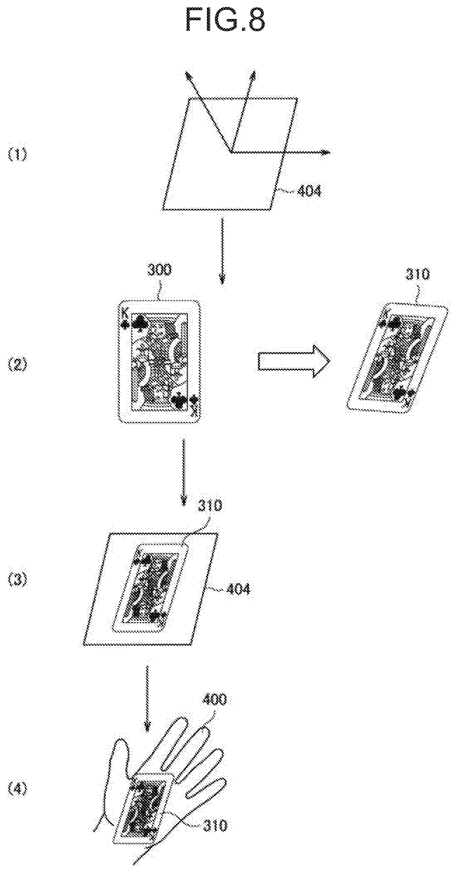

FIGS. 7 and 8 are schematic diagrams illustrating display control according to the posture of the hand 400. FIG. 7 illustrates a state in which the posture of the hand (plane 404) is estimated by the processing of FIG. 6. FIG. 8 is a schematic diagram illustrating a flow of display control processing according to the posture of the hand 400. FIG. 8 illustrates an example where display of a playing card serving as the content (A) 300 illustrated in FIG. 4 is controlled according to the posture of the hand 400.

As illustrated in FIG. 8, first, in Step (1), the position and posture of the hand estimated by the processing of FIG. 6 are acquired. Herein, the position and posture of the hand are acquired on the basis of the position of the center of gravity of the point group and the tilt of the plane 404. In the next Step (2), the display image (content (A) 300) is subjected to perspective projection transformation according to the detected posture of the hand (tilt of the plane 404). As a result, a perspective-projection-transformed content (A) 310 is obtained. In the next Step (3), processing of adjusting a display position of the content (A) 310 to the detected position of the plane 404 is performed. This processing of adjusting the display position includes processing of adjusting the position in the depth direction with respect to the projection plane and processing of adjusting the position in the direction along the projection plane. Regarding the processing of adjusting the position in the depth direction with respect to the projection plane, for example, processing such as adjusting a focal position may be performed so that the content (A) 310 is the clearest at the position of the plane 404. In the next Step S(4), the display image (content (A) 310) is displayed in a correct shape on the palm of the hand 400 of the user. The processing of Steps (2) to (4) is mainly performed by the display control unit 112.

As described above, it is possible to display the content (A) 310 in the correct shape according to the posture of the hand 400 by performing perspective projection transformation according to the posture of the hand 400. Therefore, the user can visually recognize the content (A) 310 having no distortion or the like in the correct shape on the palm.

6. Examples of Specific Operation

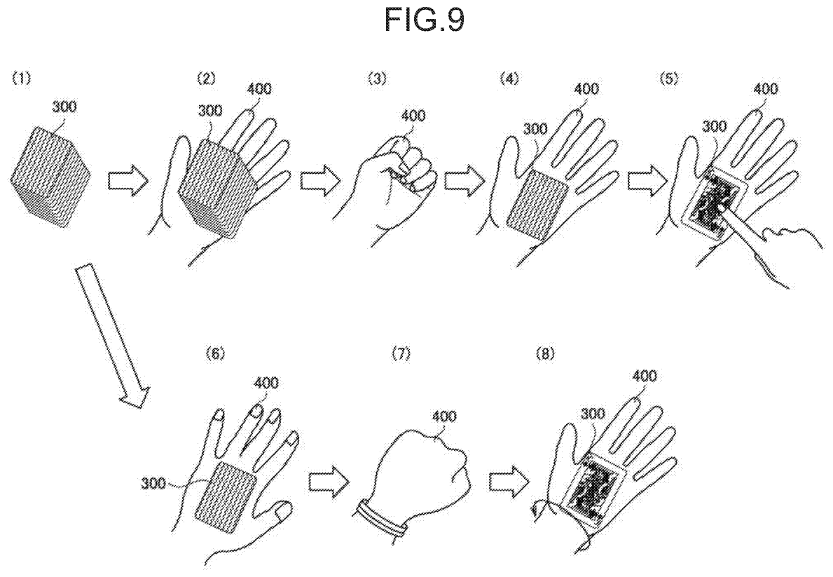

Next, specific operation performed by the user by using the projection system 1000 will be described. FIG. 9 is a schematic diagram illustrating an example where content is moved to a palm with a specific gesture and is operated. First, playing cards (content (A) 300) are projected onto the screen (Step (1)). In a case where the user holds the hand 400 over a position of the playing cards on the table 200 (Step (2)), grabs and moves the playing cards (Step (3)), and opens the hand 400, only a single playing card is displayed on the palm (Step (4)). Thereafter, in a case where the playing card displayed on the palm is tapped by the other hand, the front side of the playing card is displayed (Step (5)).

Further, in a case where, after the playing card is projected onto the screen (Step (1)), the playing card is projected onto the back of the hand 400 (Step S(6)), the playing card is grabbed and moved (Step (7)), the palm is turned over, and the hand 400 is opened, the front side of the playing card is displayed (Step (8)).

Further, in Step (2) and Step (3) in FIG. 9, the playing cards may move onto the hand 400 in a case where the hand 400 is held over the position of the playing cards and taps, or the playing cards may move onto the hand 400 in a case where the hand 400 is held over the position of the playing cards and is lifted up. Further, in Step (2) and Step (3), the playing cards may move onto the hand 400 in a case where the hand 400 is held over the position of the playing cards and the palm is turned over, or the playing cards may move to the hand 400 in a case where the playing cards are tapped with a finger and then the hand 400 is opened.

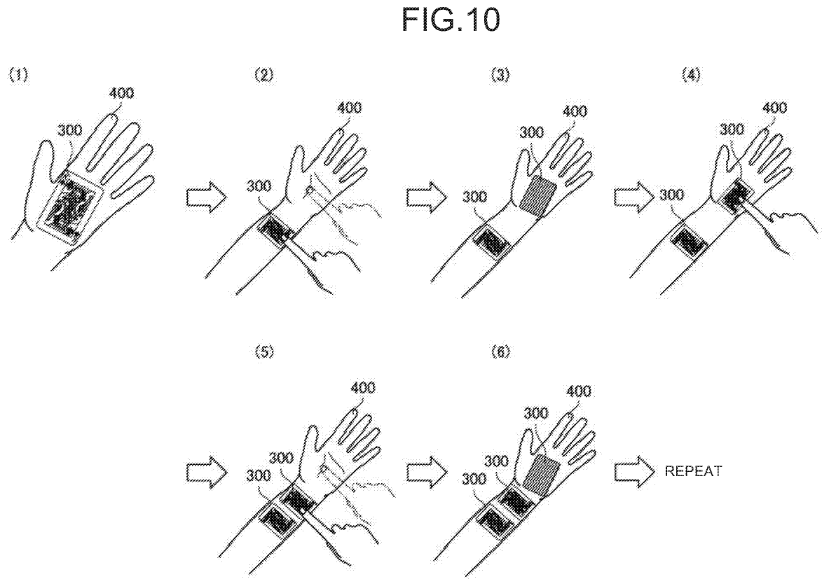

FIG. 10 is a schematic diagram illustrating an example where content on a palm is moved to an arm. First, a playing card is displayed on the palm (Step (1)), and the playing card is dragged and is moved to the arm (Step (2)). Then, another card is acquired (Step (3)) and is tapped with a finger of the other hand to display the front side of the card (Step (4)), and the playing card is dragged with the finger of the other hand to be moved to the arm (Step (5)). Then, still another playing card is acquired (Step (6)), and the processing in and after Step (4) is repeated.

In this way, in the operation of FIG. 10, it is possible to acquire the playing card on the palm by displaying the playing card on the palm and to move the playing card toward the arm by dragging the playing card.

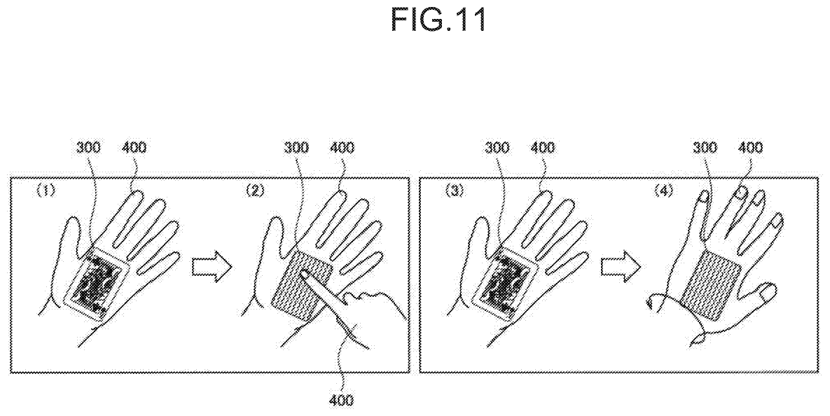

FIG. 11 is a schematic diagram illustrating operation of displaying the back side of a playing card whose front side is displayed. First, a playing card is displayed on the palm (Step (1)), and, by tapping the playing card with the other hand 400, the back side of the playing card displayed on the palm is displayed (Step (2)).

As another example, in a case where a playing card is displayed on the palm (Step (3)) and the hand 400 is turned over, the back side of the playing card displayed on the palm is displayed on the back of the hand (Step (4)).

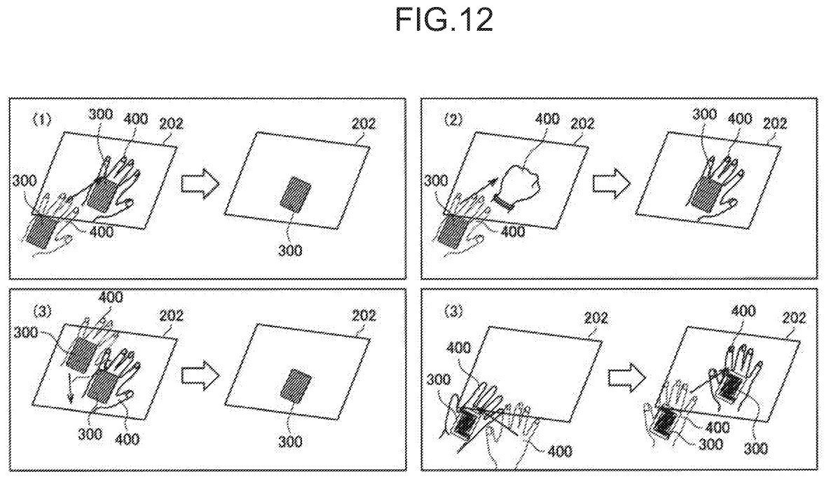

FIG. 12 is a schematic diagram illustrating operation of returning a playing card onto the table 200. FIG. 12 illustrates four examples (1) to (4) as operation of returning a playing card (content (A) 300) displayed on the hand 400 to the projection area 202.

The example (1) in FIG. 12 is an example where a playing card returns onto the table 200 in a case where the table 200 is touched with the hand 400. The example (2) in FIG. 12 is an example where a playing card returns onto the table 200 in a case were the hand 400 is clenched and unclenched on the table 200. The example (3) in FIG. 12 is an example where a playing card returns onto the table 200 in a case where the hand is lowered. The example (4) in FIG. 12 is an example where a playing card returns onto the table 200 in a case where the playing card displayed on one hand 400 is picked up with the other hand 400 and the other hand is moved onto the table 200.

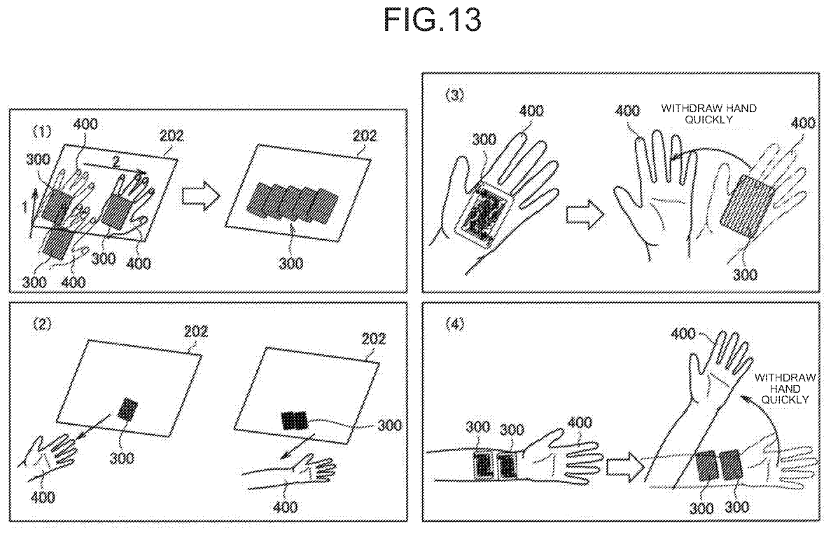

FIG. 13 is a schematic diagram illustrating another operation of returning playing cards onto the table 200. FIG. 13 also illustrates four examples (1) to (4) as operation of returning playing cards (content (A) 300) displayed on the hand 400 to the projection area 202.

The example (1) in FIG. 13 is an example where all playing cards displayed on the hand 400 return onto the table 200 in a case where the hand 400 is moved in a direction of the arrow 1 while the playing cards are being displayed on the hand 400, the table 200 is touched with the hand 400, and dragging is performed in a direction of the arrow 2.

The example (2) in FIG. 13 is an example where all playing cards displayed on the hand 400 return onto the table 200 in a case where the hand 400 is moved onto the table 200 while the playing cards are being displayed on the hand 400, and then the hand 400 is moved out of the projection area 202. All the playing cards may return onto the table 200 in a case where the hand 400 is moved onto the table 200, and then the hand 400 is moved away from the projection area 202 to a predetermined position.

The example (3) in FIG. 13 is an example where a playing card remains on the table 200 in a case where the hand 400 is quickly withdrawn while the playing card is being displayed on the hand 400. The example (4) in FIG. 13 is an example where playing cards return onto the table 200 in a case where the hand 400 is moved onto the table 200 and the hand is quickly withdrawn while the playing cards are being displayed not on the palm but on the arm.

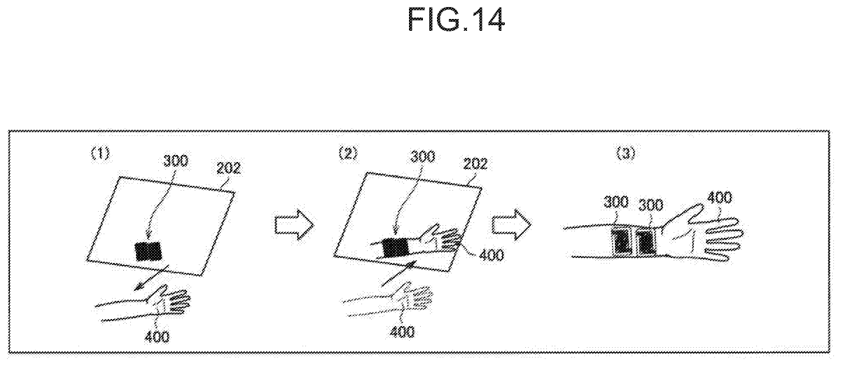

FIG. 14 is a schematic diagram illustrating a method of returning playing cards 300 onto the hand 400. First, in a case where the hand 400 is moved out of the projection area 202, a playing card whose back side is displayed returns to the projection area 202 at a predetermined position (Step (1)). Thereafter, in a case where the hand 400 is held over the playing card returned to the projection area 202 again (Step (2)), the playing card returns to the hand (Step (3)).

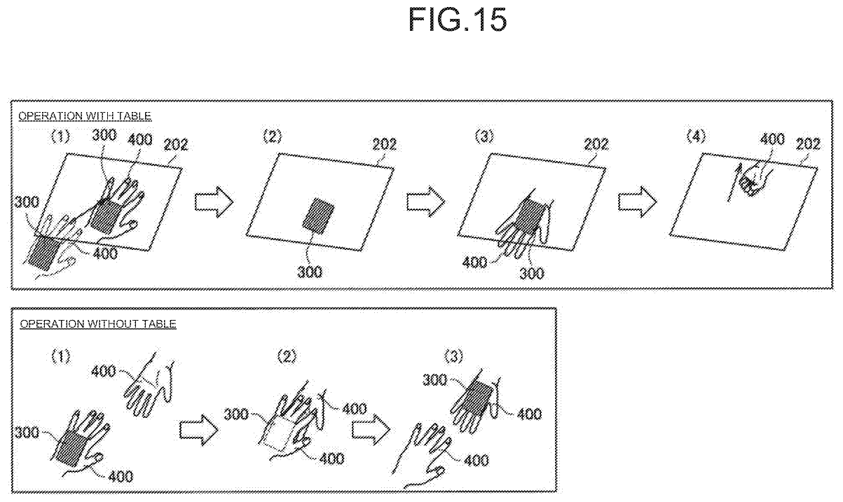

FIG. 15 is a schematic diagram illustrating operation of passing a playing card to a person. FIG. 15 illustrates operation with the table 200 and operation without the table 200. In the operation with the table 200, in a case where the table 200 is touched with the hand 400 while the playing card is being displayed on the hand 400 (Step (1)), the playing card returns onto the table 200 (Step (2)). Then, in a case where the playing card on the table 200 is projected onto a hand 400 of another person (Step (3)), and the another person clenches the hand 400, the playing card is acquired by the another person (Step (4)).

In the operation without the table 200 in FIG. 15, in a case where, in a state in which a playing card is displayed on Mr./Ms. A's hand 400 and the playing card is not displayed on Mr./Ms. B's hand 400 (Step (1)), Mr./Ms. A's hand 400 and Mr./Ms. B's hand 400 are put together (Step (2)) and are released, the playing card is passed to Mr./Ms. B's hand 400.

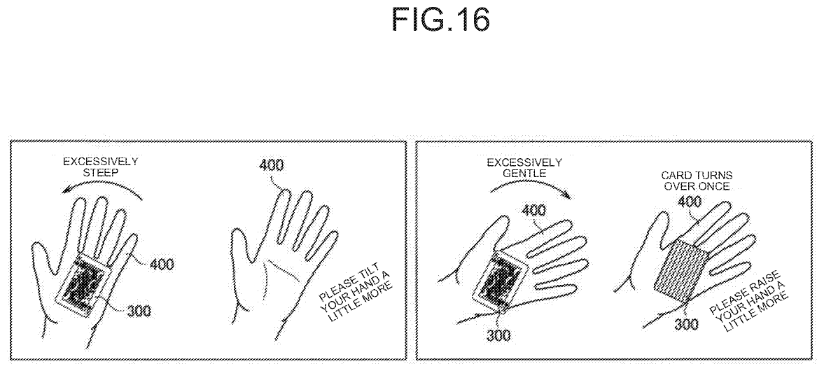

FIG. 16 is a schematic diagram illustrating an example where a change in an angle of the hand 400 is prompted by display on the table 200. According to this embodiment, in a case where the user tilts the hand 400 toward himself/herself, content displayed on the hand 400 cannot be visually recognized by other users. Thus, it is possible to use the hand 400 as a private screen. As a result, it is possible to display, on the hand 400, private information that should not be known by others. In a case where the hand 400 is excessively steep with respect to an upper surface of the table 200 as illustrated in the left diagram of FIG. 16, adverse effects such as distortion of the content may be caused. Therefore, in a case where the hand 400 is excessively steep with respect to the upper surface of the table 200, a message “Please tilt your hand a little more” is displayed on the table 200. This makes it possible to restrain the image of the playing card displayed on the hand 400 from being distorted.

In a case where the hand is excessively tilted as illustrated in the right diagram of FIG. 16, a message “Please raise your hand a little more” is displayed on the table 200. Therefore, the user raises the hand 400, and the information on the playing card (content (A) 300) cannot be seen by other people. This makes it possible to improve confidentiality of the private screen. More preferably, as illustrated in the right diagram of FIG. 16, display of the playing card is preferably hidden by turning over the playing card so that other people cannot see the display while the hand 400 is being excessively tilted. This makes it possible to improve confidentiality more securely.

Note that an example where, in a case where the playing card (content (A) 300) is displayed on the hand 400, a display state is changed in response to a gesture of the user has been mainly described in the above description. However, the display state can also be changed according to a gesture of the user in a case where the playing card is displayed on the table 200.

According to the specific operation examples described above, it is possible to present additional information to the user by recognizing the hand 400 existing in the projecting area 202 and grasping a relative position between the hand 400 and the table 200. Further, it is possible to improve usability by detecting the posture and state of the hand 400 in real time and dynamically changing the content of projection in response to user operation or gesture. Furthermore, operation of the hand 400 and a change in the content of projection can be associated by intuitive movement. This makes it possible to achieve an operation system with low learning costs. Still further, it is also possible to create a private screen by displaying content on the hand 400 in a public screen projected by the projector apparatus 100. Note that an example of displaying content such as a playing card has been described in the above examples. However, other kinds of content may be displayed, such as mahjong, a card game using cards having the front side and the back side, and Gungin shougi (kind of board game). Further, the present disclosure is applicable to, as content to be projected, various kinds of content other than the content related to the above games. Because the hand 400 can be used as a private screen as described above, it is particularly useful for displaying an application that requires confidentiality such as a personal identification number.

7. Examples of Operation Using Object Other than Hand

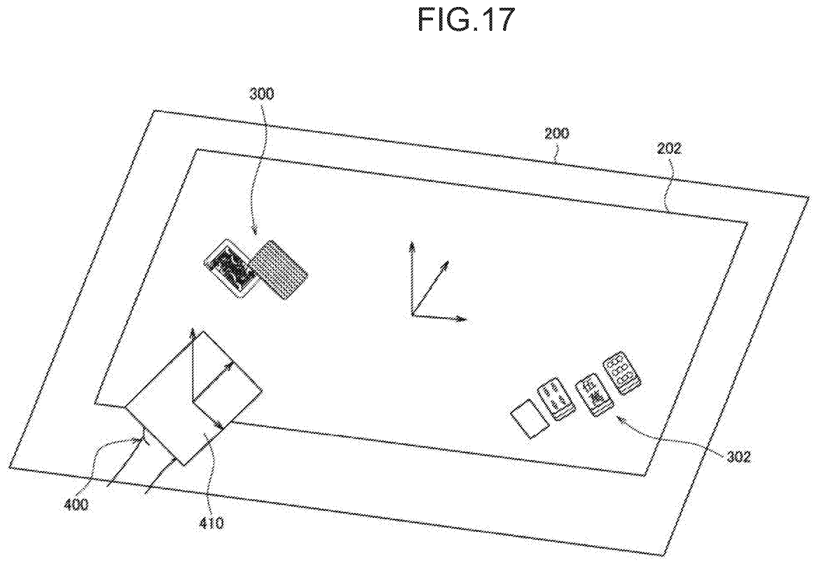

An example where a display state of information regarding the content 300 is changed in response to operation of the hand 400 of the user has been described in the above description. However, the display state of the information may be changed in response to operation other than operation of the hand 400. FIG. 17, as well as FIG. 4, is a schematic diagram illustrating an example of display on the table 200. FIG. 17 is different from FIG. 4 in that the hand 400 of the user holds a board 410. The input unit 102 acquires a state of the board 410 as the state of the object. The hand detection unit 104, the hand tracking unit 106, the hand posture estimation unit 108, and the gesture recognition unit 110 illustrated in FIG. 2 perform processing similar to that in the case of the hand 400, thereby acquiring a spatial state of the board 410. By making the board 410 white, in a case where, for example, content such as a playing card is displayed on the board 410, it is possible to display the content with clearer colors.

Further, in the example in FIG. 17, private content to be displayed only for a user to which the board 410 is distributed can be displayed on the board 410 by attaching a marker detectable by the input unit 102 to the board 410. As a result, it is possible to use the board 410 as a private screen for a specific user. In this case, the marker on the board 410 is detected by the same method as the hand detection unit 104 detects the hand 400, and, in a case where the marker is detected, the display control unit 112 displays private information on the board 410. Also in this case, it is possible to control display in response to a recognized gesture.

8. Examples of Control by Server

In the configuration example in FIG. 2, the projector apparatus 100 includes all the components in FIG. 2. However, the projector apparatus 100 includes the input unit 102 and the output unit 116, and other components may be provided in another apparatus. That is, the components of the display processing apparatus 130 surrounded by the alternate long and short dash line in FIG. 2 are not necessarily provided in the projector apparatus 100.

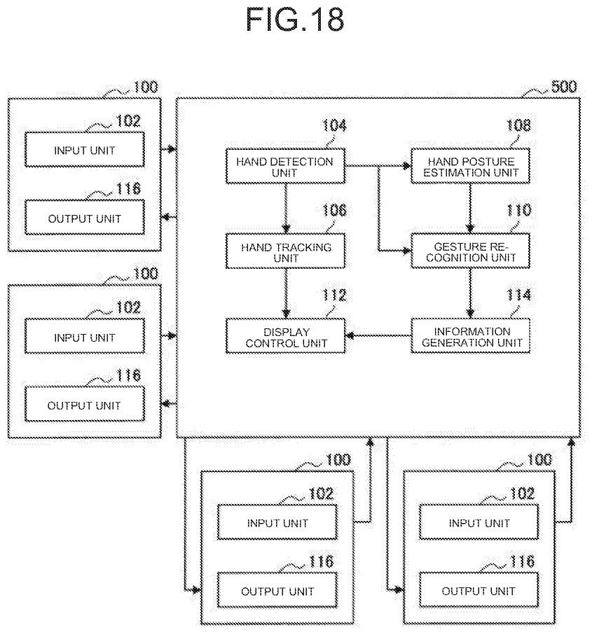

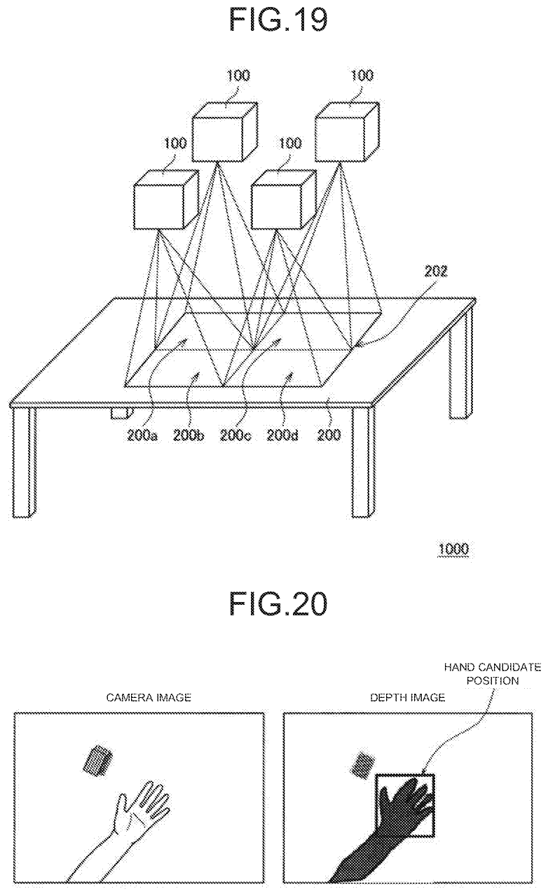

FIG. 18 is a schematic diagram illustrating a configuration example where a plurality of projector apparatuses 100 each including the input unit 102 and the output unit 116 is provided, and each of the plurality of projector apparatuses 100 is controlled by a server 500. FIG. 19 illustrates an example where display is performed in the projection area 202 of the table 200 with the configuration illustrated in FIG. 18. In the example in FIG. 19, the projection area 202 is divided into a plurality of parts, and four projector apparatuses 100 perform projection onto divided projection areas 202a, 202b, 202c, and 202d, respectively. As illustrated in FIG. 18, the server 500 that controls the projector apparatuses 100 includes the components of the display processing apparatus 130 surrounded by the one-dot chain line in FIG. 2.

According to the configuration example in FIGS. 18 and 19, the four projector apparatuses 100 can share the projection area 202 and perform display. This makes it possible to perform display on the wider projection area 202. In a boundary portion between the divided projection areas 202a, 202b, 202c, and 202d, the projector apparatuses 100 that perform display in adjacent projection areas perform superimposed display. This makes it possible to securely perform display on the boundary portion. Further, in the example in FIG. 19, each projector apparatus 100 may perform display on the entire projection area 200 so as to superimpose the display by each projector apparatus 100.

As described above, according to this embodiment, it is possible to optimally control display of content to be projected according to a spatial state of an object, such as the hand 400 or the board 410. Further, the object such as the hand 400 or the board 410 can be used as a private screen, and thus it is possible to achieve a highly confidential application that could have not been achieved by existing projection systems, without using any special device or tool. Furthermore, the content of projection can be optimized by simple and intuitive operation by associating operation of the object with a change in the content of the projection.

Hereinabove, the preferred embodiments of the present disclosure have been described in detail with reference to the accompanying drawings. However, the technical scope of the present disclosure is not limited to such examples. It is obvious that a person having ordinary knowledge in the technical field of the present disclosure can make various changes and modifications within the scope of the technical idea recited in the claims. It is understood that those changes and modifications are also included in the technical scope of the present disclosure.

Further, the effects described in the present specification are merely illustrative or exemplary and are not limited. That is, the technology according to the present disclosure can have other effects apparent to those skilled in the art from the description of the present specification, in addition to or instead of the above effects.

The following configurations are also included in the technical scope of the present disclosure.

(1)

A display processing apparatus, comprising:

a state acquisition unit configured to acquire a spatial state of an object; and

a display control unit configured to control display of projected information according to the state of the object including a posture of the object.

(2)

The display processing apparatus according to (1), wherein the state acquisition unit acquires the state of the object within a projection area in which the information is projected.

(3)

The display processing apparatus according to (1) or (2), wherein the state acquisition unit acquires, as the state of the object, a position of the object in a depth direction with respect to a projection plane.

(4)

The display processing apparatus according to (1) or (2), wherein the state acquisition unit acquires, as the state of the object, a position of the object in a direction along a projection plane.

(5)

The display processing apparatus according to any one of (1) to (4), wherein the state acquisition unit includes a detection unit configured to detect a spatial position of the object.

(6)

The display processing apparatus according to any one of (1) to (5), wherein the state acquisition unit includes a tracking unit configured to track a position of the object.

(7)

The display processing apparatus according to any one of (1) to (6), wherein the state acquisition unit includes a posture estimation unit configured to estimate the posture of the object.

(8)

The display processing apparatus according to any one of (1) to (7), wherein:

the state acquisition unit includes a recognition unit configured to recognize a gesture of the object; and

the display control unit changes a display state of the information on the basis of the gesture.

(9)

The display processing apparatus according to (8), wherein:

the object is a hand of a user; and

the gesture includes at least one of operation of clenching the hand, operation of unclenching the hand, operation of turning over a palm, operation of tapping the displayed information, operation of dragging the displayed information, operation of touching a projection area with the hand, operation of lowering the hand toward the projection area, operation of moving the hand out of the projection area, and operation of waving the hand.

(10)

The display processing apparatus according to any one of (1) to (9), wherein the display control unit changes a display state so that the information is unrecognizable according to the state of the object.

(11)

The display processing apparatus according to any one of (1) to (10), wherein:

the information is displayed in a reversible form; and

the display control unit changes a display state of the information by reversing the information to a front or back side according to the state of the object.

(12)

The display processing apparatus according to any one of (1) to (11), wherein the display control unit controls display of the information projected onto the object.

(13)

The display processing apparatus according to any one of (1) to (11), wherein the display control unit controls display of the information projected onto a predetermined projection plane.

(14)

The display processing apparatus according to any one of (1) to (13), wherein the object is an object held with a hand of a user.

(15)

A display processing method, comprising:

acquiring a spatial state of an object; and

controlling display of projected information according to the state of the object including a posture of the object.

(16)

A program for causing a computer to function as:

means for acquiring a spatial state of an object; and

means for controlling display of projected information according to the state of the object including a posture of the object.

### REFERENCE SIGNS LIST

104 HAND DETECTION UNIT
106 HAND TRACKING UNIT
108 HAND POSTURE ESTIMATION UNIT
110 GESTURE RECOGNITION UNIT
112 DISPLAY CONTROL UNIT
120 STATE ACQUISITION UNIT
130 DISPLAY PROCESSING APPARATUS

1. A display processing apparatus, comprising:
a state acquisition unit configured to acquire a spatial state of an object; and
a display control unit configured to control display of projected information according to the state of the object including a posture of the object.

2. The display processing apparatus according to claim 1, wherein the state acquisition unit acquires the state of the object within a projection area in which the information is projected.

3. The display processing apparatus according to claim 1, wherein the state acquisition unit acquires, as the state of the object, a position of the object in a depth direction with respect to a projection plane.

4. The display processing apparatus according to claim 1, wherein the state acquisition unit acquires, as the state of the object, a position of the object in a direction along a projection plane.

5. The display processing apparatus according to claim 1, wherein the state acquisition unit includes a detection unit configured to detect a spatial position of the object.

6. The display processing apparatus according to claim 1, wherein the state acquisition unit includes a tracking unit configured to track a position of the object.

7. The display processing apparatus according to claim 1, wherein the state acquisition unit includes a posture estimation unit configured to estimate the posture of the object.

8. The display processing apparatus according to claim 1, wherein:
the state acquisition unit includes a recognition unit configured to recognize a gesture of the object; and
the display control unit changes a display state of the information on the basis of the gesture.

9. The display processing apparatus according to claim 8, wherein:
the object is a hand of a user; and
the gesture includes at least one of operation of clenching the hand, operation of unclenching the hand, operation of turning over a palm, operation of tapping the displayed information, operation of dragging the displayed information, operation of touching a projection area with the hand, operation of lowering the hand toward the projection area, operation of moving the hand out of the projection area, and operation of waving the hand.

10. The display processing apparatus according to claim 1, wherein the display control unit changes a display state so that the information is unrecognizable according to the state of the object.

11. The display processing apparatus according to claim 1, wherein:
the information is displayed in a reversible form; and
the display control unit changes a display state of the information by reversing the information to a front or back side according to the state of the object.

12. The display processing apparatus according to claim 1, wherein the display control unit controls display of the information projected onto the object.

13. The display processing apparatus according to claim 1, wherein the display control unit controls display of the information projected onto a predetermined projection plane.

14. The display processing apparatus according to claim 1, wherein the object is an object held with a hand of a user.

15. A display processing method, comprising:
acquiring a spatial state of an object; and
controlling display of projected information according to the state of the object including a posture of the object.

16. A program for causing a computer to function as:
means for acquiring a spatial state of an object; and
means for controlling display of projected information according to the state of the object including a posture of the object.
